(19) United States
(12) Patent Application Publication
(10) Pub. No.: US 2004/0222043 A1
(43) Pub. Date: Nov. 11, 2004

(54) Multi-configurable segmented ladder

(76) Inventor: Benjamin Arthur Fortner, Yuma, AZ (US)

Correspondence Address: BENJAMIN ARTHUR FORTNER, 47th STREET, 12523 EAST, YUMA, AZ, 85367, US

(21) Appl. No.: 10/431,662

(22) Filed: May 9, 2003

(51) Int. Cl. E06C 1/00

(52) U.S. Cl. 182/178.3; 182/22

(57) ABSTRACT

A segmented ladder is provided that can be assembled in minutes into specific lengths of straight ladders and configured into a free standing step ladder for easy handling and selection of the proper length required for the specific work application wherein the side rails are of lightweight tubular aluminum construction and are of uniform size and parallel with each other and with the lightweight aluminum rungs permanently affixed between the side rails with the interconnections between the segments being accomplished at each side rail by a telescopic joint containing both a male and female section utilizing integral spring loaded steel detents that are activated by finger pressure when the telescopic joints are mated and are located in positional holes directionally located in the male section of the joints which engage matching holes in the female section of the joints when the joints are telescoped together thus locking the segmented sections together into either specific straight ladder lengths or a free standing step ladder with the bottom most segmented ladder section containing integral support rubber feet located in the bottom of the side rails and the bottom of the back brace segments and the top most segmented ladder section containing an integral rubber cap located on the top of the side rails to prevent marring any surface against which the ladder may be placed with disassembly of the ladder being accomplished in a reverse manner to the assembly by pressing-in the detents using finger pressure and sliding the telescopic joints apart thus providing a shorter more compact over-all packageable configuration which provides more convenient and secure storage.

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to a multi-configurable segmented ladder and improvements thereon.

Conventional ladders formed in a fixed configuration and length have been used for many years. These ladders are impossible to adjust to permit users to adapt the proper height ladder for the job to be accomplished. Storage of fixed length ladders has been a problem through the ages. Folding and extension ladders have been developed in an attempt at adjustability and to permit storage in a smaller space, but the problem of multi-configurations and compact storage has not been totally overcome.

A multi-configurable ladder which can be easily configured into a variety pf straight ladders and a free standing step ladder would provide maximum efficiency in job adaptability and also allow compact storage.

### BRIEF SUMMARY OF THE INVENTION

The object of this invention is to provide multiple configurations, both straight ladders and a step ladder, in a compactly stored, lightweight, simply and easily assembled, strong, segmented ladder.

The invention permits the user to adapt the proper height or configuration to the job that need to be performed, and yet affords for easy assembly and disassembly as well as compact storage.

This invention solves previously existing problems of ladder length, ladder adaptability to job requirements, ladder weight, easy assembly and disassembly with no hinges, levers or bolts and nuts, all in a compact storage configuration. Maximum efficiency and adaptability is achieved by this invention of the multi-configurable segmented ladder.

### BRIEF DESCRIPTION OF THE SEVERAL VIEWS OF THE DRAWING

FIG. 1 is a view of the bottom segment of the segmented ladder depicting the shortest climbing length as a straight ladder.

FIG. 2 is a view of the bottom and top segments of the segmented ladder inter-connected and depicting the intermediate climbing length as a straight ladder.

FIG. 3 is a view of the bottom, middle and top segments of the segmented ladder interconnected and depicting the longest climbing length as a straight ladder.

FIG. 4 is a view of the bottom segment interconnected with the back brace segments thus depicting a free standing ladder.

FIG. 5 is a typical sectional view of the male interconnection with the double detent spring pins.

FIG. 6 is a typical sectional view of the female interconnection with the holes to receive the detent pins.

FIG. 7 is a typical sectional view of the mated interconnecting joints.

### DETAILED DESCRIPTION OF THE INVENTION

This description is not to be taken in a limiting sense but is made for the sole purpose of illustrating the invention.

The following is a detailed description of the presently preferred embodiment of the multi-configurable segmented ladder. All side rails 12, rungs 4, male interconnecting joints 8, back braces 9 and 10, and cross brace 11, are all depicted as aluminum material.

Referring to FIG. 1, in the present embodiment the bottom segment 1, is shown which contain permanently affixed to the side rails l2, the rungs 4, integral support rubber feet 5, permanently affixed interconnecting male section 8, and the double detent steel spring pins 6. The rungs 4, and the rubber feet 5, are angles at 14½° which is prescribed by the American National Safety Institute (ANSI) regulations, and the 14½° tread surfaces are parallel in segment 1, 2 and 3 which define the climbing side of the ladder. Disassembly is accomplished by reversing the assembly sequence.

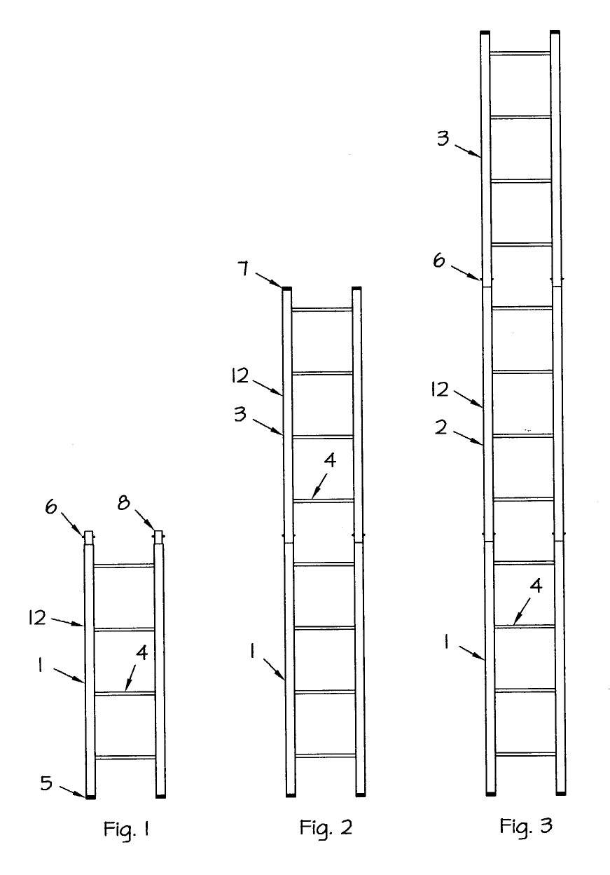

Referring to FIG. 2, in the present embodiment the bottom segment 1, is shown interconnected to the top segment 3, in a manner as shown by Figs 5, 6, and 7 which depict a typical male/female interconnecting joint locked in place by the spring pins 6, with the integral rubber caps are shown as 7, thus depicting an intermediate climbing length straight ladder. Disassembly is accomplished by reversing the assembly sequence.

Referring to FIG. 3, in the present embodiment the bottom segment 1, is shown interconnected to the middle segment 2, and the top segment 3, in a manner as shown by FIGS. 5, 6 and 7 which depict a typical male/female interconnecting joint locked in place by the spring pins 6, thus depicting the longest climbing length strait ladder. Disassembly is accomplished by reversing the assembly sequence.

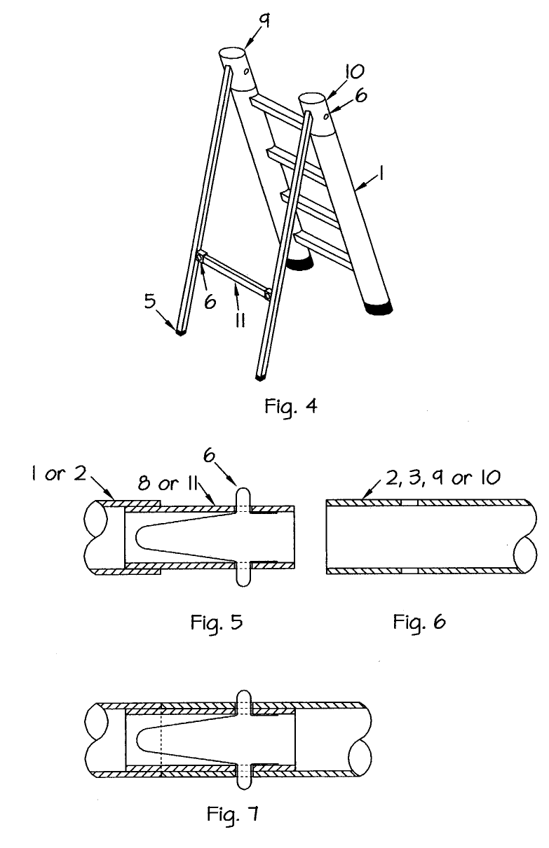

Referring to FIG. 4, in the present embodiment the bottom segment 1, is shown interconnected to the back brace segments 9 and 10, with integral support rubber feet 5, which contain a female joint that connects with each side rail 12, male joint 8, and a female joint which connects with the male joint located in each end of the cross brace 11, in a manner as shown by FIGS. 5, 6 and 7 which depict a typical male/female interconnecting joint locked in place by the spring pins 6, thus depicting the free standing ladder configuration. Disassembly is accomplished by reversing the assembly sequence.

Referring to FIG. 5, in the present embodiment the male interconnecting joint 8 or 11, is shown with the spring pin 6, installed in positional holes directionally located.

Referring to FIG. 6, in the present embodiment the female interconnecting joint 2, 3, 9 or 10, is shown with integral positional directionally locating spring pin engagement holes.

Referring to fig. 7, in the present embodiment the interconnecting joint is shown assembled and locked in place by the spring pin 6, which is activated by finger pressure to depress the detents while the female interconnecting joint 2, 3, 9 or 10, is slid over the male interconnecting joint 8 or 11, thus permitting the spring loaded detents to engage the engagement holes in 2, 3, 9,or 10.

1-3. (Canceled)

4. A segmented multi-configurable ladder, comprising:
at least two ladder segments, each ladder segment including a pair of tubular side rails, the at least two ladder segments capable of being connected at telescopic joints on the side rails, each telescopic joint having a male section having two engagement holes and a female section having two engagement holes; and
a finger pressure actuated spring pin mounted within the male section of each telescopic joint, each spring pin having two integral detents protruding from the two engagement holes of the male section, the two integral detents also protruding from the two engagement holes of the female section when and only when the telescopic joints are mated, thereby locking the at least two ladder segments together.

5. A method of locking together segments of a ladder, the ladder including at least two ladder segments, each ladder segment including a pair of tubular side rails, the at least two ladder segments capable of being connected at telescopic joints on the side rails, each telescopic joint having a male section having two engagement holes and a female section having two engagement holes, and a spring pin mounted within the male section of each telescopic joint, each spring pin having two integral detents protruding from the two engagement holes of the male section, comprising the steps of:
(a) pushing with the fingers of a user the two integral detents into the male section such that the two integral detents do not protrude from the two engagement holes of the male section;
(b) sliding the male section of the telescopic joint into the female section of the telescopic joint; and
(c) permitting the two integral detents to protrude through both the two engagement holes of the male section and the two engagement holes of the female section, thereby locking the at least two ladder segments together.

6. A method of unlocking segments of a ladder locked together, the ladder including at least two ladder segments, each ladder segment including a pair of tubular side rails, the at least two ladder segments capable of being connected at telescopic joints on the side rails, each telescopic joint having a male section having two engagement holes and a female section having two engagement holes, and a spring pin mounted within the male section of each telescopic joint, each spring pin having two integral detents, the two integral detents protruding through both the two engagement holes of the male section and the two engagement holes of the female section, comprising the steps of:
(a) pushing with the fingers of a user the two integral detents through both the two engagement holes of the male section and the two engagement holes of the female section and into the male section such that the two integral detents do not protrude from the two engagement holes of the male section;
(b) sliding the male section of the telescopic joint out of the female section of the telescopic joint; and
(c) permitting the two integral detents to protrude through the two engagement holes of the male section.
